(19) United States
(12) Patent Application Publication
(10) Pub. No.: US 2005/0062855 A1
(43) Pub. Date: Mar. 24, 2005

(54) Circuit for adjusting a signal by feeding back a component to be adjusted

(75) Inventors: Kuniyuki Tani, Ogaki-city (JP); Atsushi Wada, Ogaki-city (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 10/918,359

(22) Filed: Aug. 16, 2004

(30) Foreign Application Priority Data
Sep. 24, 2003 (JP) 2003-332499

(51) Int. Cl. H04N 5/228

(52) U.S. Cl. 348/222.1

(57) ABSTRACT

A signal adjustment circuit which aims to simplify measurement of a component to be adjusted and to improve precision of adjustment. An analog front-end circuit of an imaging device corresponds to a signal processing circuit. By feeding back a black-level signal that is the component to be adjusted, the black-level signal is removed from an imaging signal. A black-level adjustment circuit includes a bypass circuit for allowing the black-level signal to be fed back to bypass a PGA that is a variable gain amplifier. When a black level is measured, the black-level signal passes through the bypass circuit. Thus, setting of a gain does not affect on the black-level signal. An offset component of the PGA has no adverse effect on the measurement of the black level. Moreover, a structure may be provided that inputs a reference voltage to an AD converter and detects and cancels an offset component of the AD converter. Furthermore, a similar structure may be also provided for the PGA.

### BACKGROUND OF THE INVENTION

1. Field of the Invention

The present invention relates to a signal adjustment circuit for removing a component to be adjusted from a signal passing through a signal processing circuit. A typical example of the signal adjustment circuit is a black-level adjustment circuit of an imaging device.

2. Description of the Related Art

It is conventionally known to provide a black-level adjustment circuit in an analog front-end circuit for processing an output signal of a solid-state image sensing device such as a CCD. The black-level adjustment circuit measures an output from an element for which light incident thereon is blocked as a black level, and subtracts the black level thus measured from an output from an element onto which light is incident so as to pick up image information only.

FIG. 8 illustrates an exemplary analog front-end circuit of a conventional imaging device, together with a black-level adjustment circuit. As shown in FIG. 8, the analog front-end circuit 101 includes a correlated double sampling circuit (hereinafter, simply referred to as CDS) 102, a programmable variable gain amplifier (hereinafter, simply referred to as PGA) 103, and an AD converter 104. The programmable variable gain amplifier is an exemplary variable gain amplifier. In the above structure, a signal from an imaging device is sampled by the CDS 102, and is then amplified by the PGA 103 in such a manner that the maximum value in a period in which imaging is performed is coincident with a range of an input voltage of the AD converter 104. Then, the AD converter 104 converts the thus amplified signal into a digital signal. Thus, the imaging signal is processed in a digital region.

The black-level adjustment circuit 110 is a circuit that feeds back a measured value of the black level, and includes a digital processing circuit 111, a DA converter 112, and a subtractor 113, as shown in FIG. 8. The measurement of the black level is performed by using a similar path to that of the aforementioned imaging signal. In other words, during the measurement of the black level, an output signal of a blocked element of the solid-state image sensing device is supplied to the aforementioned analog front-end circuit 101. Then, a digital value provided by the AD converter 104 is obtained as the black level. The digital value of the black level is processed by the digital processing circuit 111, is then converted by the DA converter 112 into an analog signal, and is finally supplied to the subtractor 113. The subtractor 113 subtracts the analog signal of the black level from the imaging signal.

FIG. 9 illustrates another exemplary conventional black-level adjustment circuit. In the circuit shown in FIG. 9, the subtractor 113 for subtracting the black level is inserted after the CDS 102. Except for the position of the subtractor 113, the structure shown in FIG. 9 is the same as that shown in FIG. 8.

Moreover, a conventional technique for a variable gain amplifier is disclosed in Yoshihisa Fujimoto et al., “A Switched-Capacitor Variable Gain Amplifier for CCD Image Sensor Interface System”, ESSCIRC (European Solid-State Circuit Conference) 2002, pp. 363-366.

According to the conventional technique, during the measurement of the black level, the signal of the black level that is an object of the measurement passes through the variable gain amplifier. In order to prevent amplification of this black-level signal when this black-level signal passes through the variable gain amplifier, a process for setting a gain of the variable gain amplifier to one is performed. This process makes the black-level measurement complicated. Alternatively, the black level may be measured while the variable gain amplifier has a certain gain. In this case, the measured value of the black level is divided by that gain by the digital processing circuit. However, in this case, the structure of the digital processing circuit becomes complicated.

In addition, according to the conventional technique, an offset component of the variable gain amplifier is added to the measured value of the black level. This offset component increases a measurement error and reduces precision of adjustment.

Moreover, an offset component of the AD converter is also added to the measured value of the black level. This offset component is mixed into the black level and is amplified when the imaging signal is processed, thus reducing the precision of adjustment.

In the above description, the background of the present invention has been described. referring to the adjustment of the black level of the imaging device as an example. The similar description can be applied to another circuit for adjusting a component to be adjusted that is other than the black level by feeding back the component to be adjusted.

### SUMMARY OF THE INVENTION

The present invention was made in view of the background mentioned above, and it is an object of the present invention to improve adjusting performance of a signal adjustment circuit.

According to one aspect of the present invention, a signal adjustment circuit is provided. This signal adjustment circuit is provided in a signal processing circuit for processing a signal containing a component to be adjusted, and removes the component to be adjusted from the signal passing through the signal processing circuit by feeding back the component to be adjusted. The signal adjustment circuit of the present invention includes a bypass circuit for allowing a signal of the component to be adjusted that is to fed back, to bypass a gain amplifier forming the signal processing circuit when the signal of the component to be adjusted is measured. A suitable structure for the “gain amplifier” is a variable gain amplifier, for example.

According to this aspect, the signal of the component to be adjusted that is to be fed back bypasses the gain amplifier. Therefore, a gain setting process for the gain amplifier that is performed for measurement of the component to be adjusted can be eliminated, thus simplifying the measurement of the component to be adjusted.

Moreover, according to this aspect, the signal of the component to be adjusted that is to be fed back bypasses the gain amplifier. Therefore, an effect of an offset component of the gain amplifier in adjustment using a measured value of the component to be adjusted can be reduced and precision of the adjustment can be improved.

According to another aspect of the present invention, a signal adjustment circuit includes a circuit for inputting a reference voltage to an AD converter that forms a signal processing circuit, and a circuit for canceling an offset component of the AD converter that is measured by using the reference voltage. According to this aspect, since the offset component of the AD converter is canceled out, the precision of the adjustment can be improved.

According to still another aspect of the present invention, the signal adjustment circuit includes a bypass circuit for allowing a signal of a component to be adjusted that is to be fed back to bypass a gain amplifier forming a signal processing circuit when the signal of the component to be adjusted is measured. The bypass circuit allows that signal to bypass at least a part of amplifiers provided in a plurality of stages in the gain amplifier. As described above, the bypass circuit may be provided for a part of amplifiers provided in a plurality of stages that form the gain amplifier within the scope of this aspect of the invention. In this case, an effect of an offset component of the bypassed amplifier can be reduced and therefore the precision of the adjustment can be improved.

According to still another aspect of the present invention, a signal adjustment circuit includes a circuit for inputting a reference voltage to at least one of amplifiers provided in a plurality of stages in a gain amplifier that forms a signal processing circuit, and a circuit for canceling an offset component of an amplifier that is measured by using the reference voltage. According to this aspect, the offset component of the gain amplifier is canceled out. Therefore, the precision of the adjustment can be improved.

A given combination or substitution of the above-described components, or a method that embodies the present invention can form a possible aspect of the present invention. Moreover, the present invention is not limited to the signal adjustment circuit mentioned above. The present invention can be also applied to a signal processing circuit, a black-level adjustment circuit or device, an imaging device, and an analog front-end circuit of an imaging device.

According to the present invention, adjusting performance of the signal adjustment circuit can be improved.

### BRIEF DESCRIPTION OF THE DRAWINGS

FIG. 1 is a diagram of a signal adjustment circuit according to a first embodiment of the present invention.

FIG. 2 is a diagram of a signal adjustment circuit according to a second embodiment of the present invention.

FIG. 3 is a diagram of a signal adjustment circuit according to a third embodiment of the present invention.

FIG. 4 is a diagram of a signal adjustment circuit according to a fourth embodiment of the present invention.

FIG. 5 is a diagram of a signal adjustment circuit according to a fifth embodiment of the present invention.

FIG. 6 is a diagram of a signal adjustment circuit according to a sixth embodiment of the present invention.

FIG. 7 is a diagram of a signal adjustment circuit according to a seventh embodiment of the present invention.

FIG. 8 is a diagram of an exemplary conventional signal adjustment circuit.

FIG. 9 is a diagram of another exemplary conventional signal adjustment circuit.

### DETAILED DESCRIPTION OF THE INVENTION

The present invention will now be described based on the preferred embodiments, with reference to drawings. In the preferred embodiments, a signal adjustment circuit is a black-level adjustment circuit of an imaging device.

(Embodiment 1)

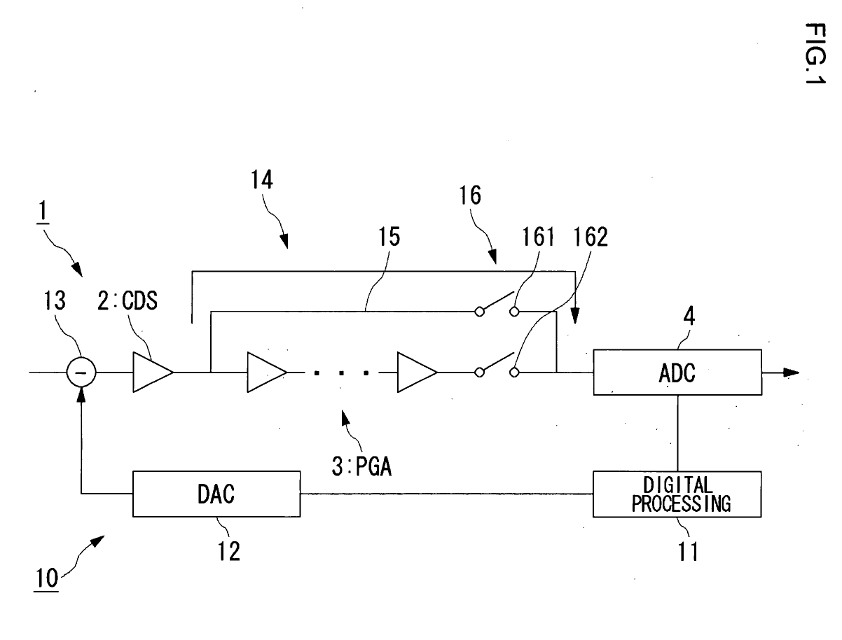

FIG. 1 illustrates an imaging device according to a first embodiment of the present invention. In particular, FIG. 1 illustrates a part of the imaging device that includes an analog front-end circuit, together with a black-level adjustment circuit. The analog front-end circuit 1 includes a correlated double sampling circuit (hereinafter, simply referred to as CDS) 2, a programmable variable gain amplifier (hereinafter, simply referred to as PGA) 3, and an AD converter 4, as shown in FIG. 1. The programmable variable gain amplifier is an exemplary variable gain amplifier.

The black-level adjustment circuit 10 includes as a basic structure a digital processing circuit 11, a DA converter 12, and a subtractor 13, as shown in FIG. 1. The black-level adjustment circuit 10 can feed back a measured value of a black level by means of this structure.

The black-level adjustment circuit 10 further includes a bypass circuit 14 as a detour to avoid the PGA 3. This is a characteristic structure in the present embodiment. The bypass circuit 14 is provided for allowing the signal of the black-level that is to be fed back (corresponding to a signal of a component to be adjusted of the present invention) to bypass the PGA 3.

The bypass circuit 14 includes a bypass line 15 and a switching circuit 16. The bypass line 15 connects the CDS 2 and the AD converter 4 to each other. Thus, the bypass circuit 14 inputs a signal from a point immediately after the CDS 2 directly to the AD converter 4. The switching circuit 16 is a device for switching a route passing through the PGA 3 and the bypass and includes a switch 161 and a switch 162. The switch 161 is provided in the bypass line 15 and the switch 162 is provided between the PGA 3 and the AD converter 4.

An operation of the device shown in FIG. 1 is now described. First, an operation when a typical imaging signal (an output signal from a pixel onto which light is incident) is supplied from an imaging device is described. The imaging device is a CCD or a CMOS sensor, for example. When the imaging signal is processed, the switch 162 in the main route in the switching circuit 16 is closed while the switch 161 in the bypass line 15 is opened. The imaging signal is sampled by the CDS 2 and is then amplified by the PGA 3 in such a manner that the maximum value in a certain period in which the imaging is performed is coincident with a range of an input voltage of the AD converter 4. Then, the AD converter 4 converts the thus amplified signal into a digital signal. Thus, the imaging signal is processed in the digital region.

Next, an operation of the black-level adjustment circuit 10 is described. When a black level is measured, the switch 162 in the main route in the switching circuit 16 is opened while the switch 161 in the bypass line 15 is closed. In this state, the signal of the black level, i.e., an output signal from a blocked pixel of the imaging device in the present embodiment, is supplied. The black-level signal is sampled by the CDS 2 and thereafter it is input to the AD converter 4 through the bypass circuit 14. That is, the black-level signal does not pass through the PGA 3. Then, a digital value of the black level is output from the AD converter 4. In this manner, a measured value of the black level is obtained. The measured digital value of the black level is processed by the digital processing circuit 11, is converted into an analog signal by the DA converter 12 and is supplied to the subtractor 13. In the subtractor 13, the analog signal of the black level is subtracted from the imaging signal.

In the above adjustment, a timing of measurement of the black level may be set in an appropriate manner in accordance with the specification of the imaging device or the like. The black level may be measured every time the imaging is performed or may be measured at longer intervals. The measured value of the black level is stored and held in the digital processing circuit 11, if necessary.

As described above, according to the present embodiment, the signal of the black level passes through the bypass line 15. Thus, it is not necessary to consider setting of the gain of the PGA 3 when the black level is measured and the need of the gain setting process is eliminated. Moreover, since the gain of the PGA 3 is not added to the black-level signal, it is not necessary to divide the measured value of the black level by the gain in the digital processing circuit 11 when the black-level signal is fed back. Therefore, with respect to this point, it is possible to prevent the digital processing circuit 11 from becoming complicated.

According to the present invention, the signal of the component to be adjusted, which is to be fed back, bypasses a variable gain amplifier. Thus, the gain setting process for the variable gain amplifier that is performed for measurement of the component to be adjusted can be eliminated. This can make simplify the measurement of the component to be adjusted.

Moreover, according to the present embodiment, the offset component of the PGA 3 is not added to the black-level signal because the black-level signal passes through the bypass line 15. Thus, even if the gain of the PGA 3 is changed, it is not necessary to set the black level again so as to reflect the change of the gain. In a case where the black level was not set again, the offset component is not distributed.

As described above, according to the present invention, the signal of the component to be adjusted, that is to be fed back, bypasses the variable gain amplifier. Thus, the effect of the offset component of the variable gain amplifier in adjustment using the measured value of the component to be adjusted can be reduced and therefore precision of the adjustment can be improved.

(Embodiment 2)

Next, a second embodiment of the present invention is described. In this embodiment, a detection configuration for detecting the offset component of the AD converter is provided.

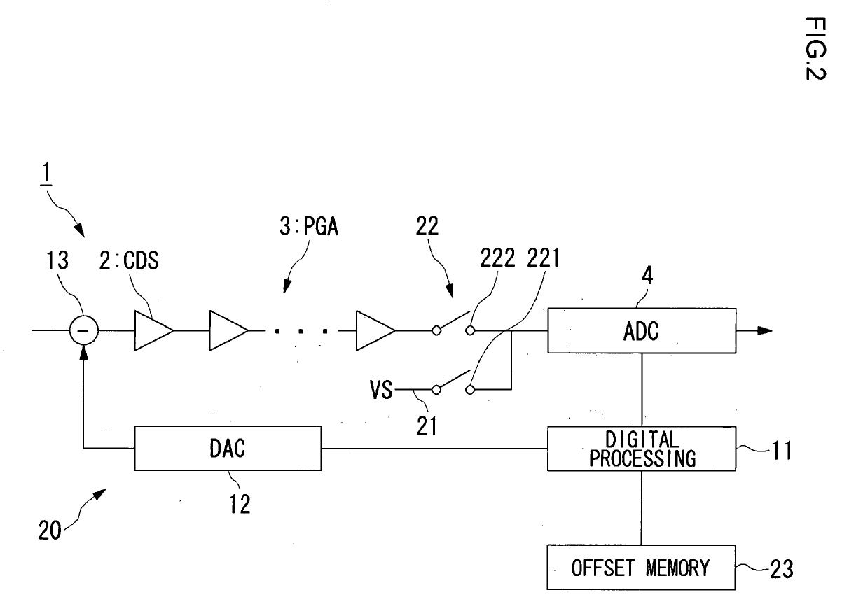

FIG. 2 illustrates a circuit structure according to the second embodiment of the present invention. In FIG. 2, the same parts as those in FIG. 1 are labeled with the same reference numerals as those in FIG. 1. In the following description, differences between the present embodiment and the first embodiment are mainly described.

As shown in FIG. 2, a black-level adjustment circuit 20 of the present embodiment includes a reference voltage input line 21 and a switching circuit 22. The reference voltage input line 21 is connected to the AD converter 4 and inputs a reference voltage VS to the AD converter 4. The switching circuit 22 is a device for switching a main route of an imaging signal and the reference voltage input line 21, and includes a switch 221 and a switch 222. The switch 221 is provided in the reference voltage input line 21, while the switch 222 is provided in the main route from the PGA 3.

Moreover, an offset memory 23 is connected to the digital processing circuit 11. The offset memory 23 stores a detected value of the offset component of the AD converter 4.

An operation of the device shown in FIG. 2 is now described. When a typical imaging signal is processed, the switch 222 in the main route in the switching circuit 22 is closed and the switch 221 in the reference voltage input line 21 is opened. Thus, the imaging signal is supplied to the CDS 2, the PGA 3, and the AD converter 4 in that order, thereby being processed in a similar manner to that in the device shown in FIG. 1.

Detection of the offset component of the AD converter 4 is performed before measurement of the black level. During that detection, the switch 222 in the main route in the switching circuit 22 is opened and the switch 221 in the reference voltage input line 21 is closed. Thus, the reference voltage VS is input to the AD converter 4, so that the offset component thereof is obtained as a digital value provided by the AD converter 4. The offset component is processed by the digital processing circuit 11 and is then stored in the offset memory 23.

The thus detected offset component will be used later in adjustment of the black level. When the black level is measured, the signal of the black level (the output from the blocked pixel) is supplied and then a measured value of the black level is obtained as a digital value provided by the AD converter 4. The digital processing circuit 11 reads out the offset component of the AD converter 4 from the offset memory 23 and subtracts the thus read offset component from the measured value of the black level. The black-level signal after subtraction is converted into an analog signal by the DA converter 12 and is then supplied to the subtractor 13, thereby being fed back. According to the present embodiment, since the offset component of the AD converter 4 is subtracted from the black level in the digital processing circuit 11, the effect of the offset component of the AD converter 4 can be eliminated.

In the above process, the timing of the detection of the offset component of the AD converter 4 may be set in an appropriate manner in accordance with the specification of the imaging device or the like. The offset component of the AD converter 4 may be measured immediately before each measurement of the black level or may be measured at longer intervals. The offset component of the AD converter 4 may be detected when the imaging device is turned on, so as to be held. In this case, the held offset value may be used in each measurement of the black level.

In the above description, the second embodiment of the present invention has been described. In the second embodiment, the reference voltage input line 21 and the switching circuit 22 function as a circuit for inputting the reference voltage VS to the AD converter 4, while the digital processing circuit 11 and the offset memory 23 function as a circuit for canceling out the offset component of the AD converter 4 that is measured by using the reference voltage VS. In a case where the AD converter 4 is a differential input type, the circuit for inputting the reference voltage may be a circuit for short-circuiting plus and minus terminals of the AD converter 4.

As described above, according to the present invention, the offset component of the AD converter measured by using the reference voltage is canceled from the signal that is processed in the signal processing circuit. Thus, the precision of adjustment can be improved.

(Embodiment 3)

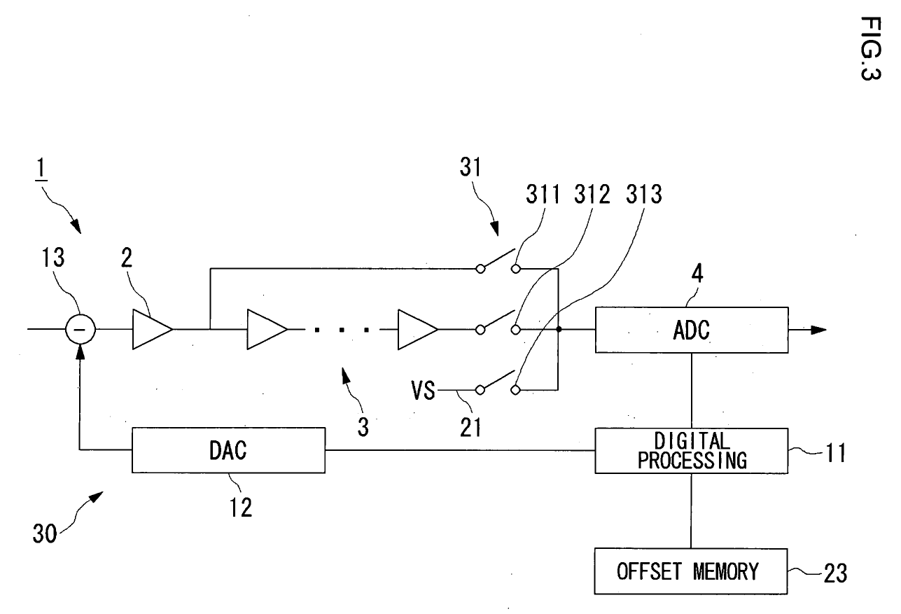

FIG. 3 illustrates a circuit structure according to a third embodiment of the present invention. In FIG. 3, the same parts as those in FIGS. 1 and 2 are labeled with the same reference numerals as those in FIGS. 1 and 2. In the following description, differences between the present embodiment and the first and second embodiments are mainly described.

The structure shown in FIG. 3 corresponds to a combination of the structures shown in FIGS. 1 and 2 (first and second embodiments). A black-level adjustment circuit 30 includes the digital processing circuit 11, the DA converter 12, and the subtractor 13. The black-level adjustment circuit 30 further includes the bypass circuit 14 for allowing a signal to bypass the PGA 3 and also includes the reference voltage input line 21 and the offset memory 23 in order to detect and cancel the offset component of the AD converter 4.

The black-level adjustment circuit 30 includes a switching circuit 31 that is formed by a switch 311 in the bypass line 15, a switch 312 in the main route from the PGA 3, and a switch 313 in the reference voltage input line 21. The switching circuit 31 switches connections between the main route, the bypass line 15 and the reference voltage input line 21, and the AD converter 4.

More specifically, when the imaging signal is processed, the switch 311 is opened; the switch 312 is closed; and the switch 313 is opened. Thus, the PGA 3 is connected to the AD converter 4 and the imaging signal is processed.

When the offset component of the AD converter 4 is detected, the switches 311 and 312 are opened while the switch 313 is closed. Thus, the reference voltage input line 21 is connected to the AD converter 4 to detect the offset component. The detected offset component is stored in the offset memory 23.

When the black level is measured, the switch 311 is closed while the switches 312 and 313 are opened. Thus, the CDS 2 and the AD converter 4 are connected and therefore the signal of the black level goes from the CDS 2 to the AD converter 4 without passing through the PGA 3, so that the black-level signal is measured. Then, the offset component of the AD converter 4 is subtracted from the measured value of the black level and the black-level signal after subtraction is fed back.

The process for the imaging signal, the detection of the offset component, and the adjustment of the black level are performed in a manner described in the first and second embodiments. Therefore, the detailed description of those processes is omitted.

According to the present embodiment, the same advantageous effects as those described in the first and second embodiments can be achieved.

In the present embodiment, the circuit is arranged in such a manner that the offset component of the PGA 3 is not added to the black level and the offset component of the AD converter 4 is subtracted from the black level. Thus, only the value of the black level can be fed back. Therefore, according to the present invention, the effects of the offset components of both the variable gain amplifier and the AD converter can be reduced and it is possible to feed back the component to be adjusted only.

(Embodiment 4)

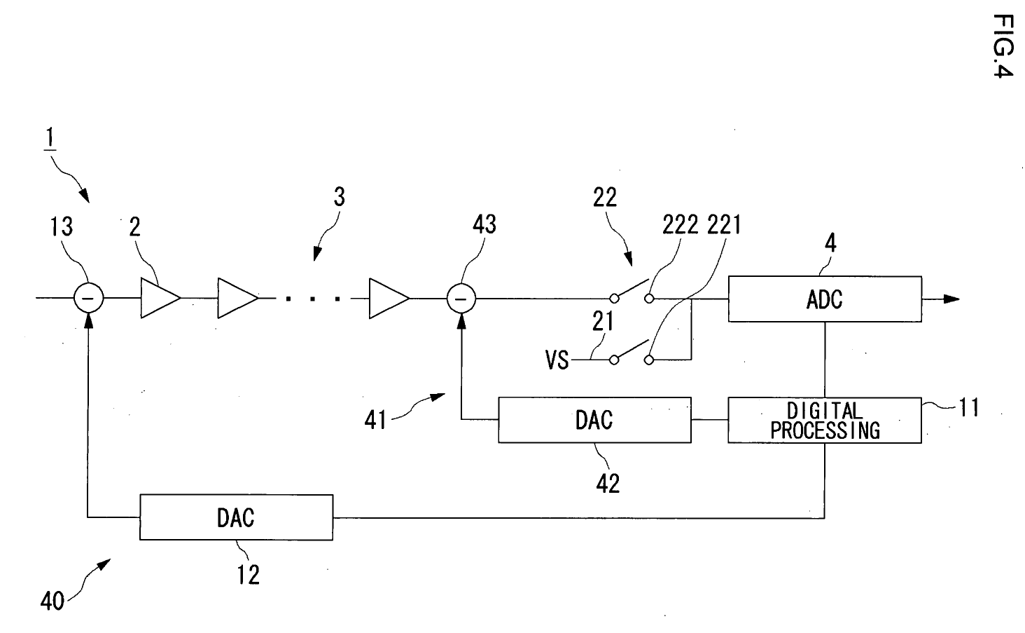

FIG. 4 illustrates a circuit structure according to a fourth embodiment of the present invention. In FIG. 4, the same parts as those in FIGS. 1 through 3 are labeled with the same reference numerals as those in FIGS. 1 through 3. In the following description, differences between the present embodiment and the first to third embodiments are mainly described.

The present embodiment corresponds to an application of the second embodiment (FIG. 2). The present embodiment is different from the second embodiment in the structure for canceling out the detected value of the offset component of the AD converter 4.

In a black-level adjustment circuit 40 shown in FIG. 4, another feedback circuit 41 is provided separately from the circuit for feeding back the black level. The feedback circuit 41 feeds back the detected value of the offset component of the AD converter 4, and includes a DA converter 42 and a subtractor 43. The subtractor 43 is arranged between the PGA 3 and the AD converter 4. The DA converter 42 is configured to convert a signal received from the digital processing circuit 11 into an analog signal and to supply the analog signal to the subtractor 43.

An operation of the device shown in FIG. 4 is now described. In the present embodiment, the offset component of the AD converter 4 is detected immediately before measurement of the black level. This detection is performed in a similar manner to that described in the aforementioned embodiment, and while the detection is performed, the switch 222 is opened and the switch 221 is closed. Thus, the reference voltage VS is input to the AD converter 4, thereby the offset component of the AD converter 4 is obtained.

The thus obtained offset component is processed by the digital processing circuit 11, and is then supplied to the DA converter 42 where the offset component is converted into an analog signal. The analog signal of the offset component is supplied to the subtractor 43 when the black level is measured. In the measurement of the black level, the switch 221 is opened and the switch 222 is closed, thereby the signal of the black level is supplied. Simultaneously, the offset component of the AD converter 4 is supplied to the subtractor 43. Then, the subtractor 43 subtracts the offset component of the AD converter 4 from the black-level signal. In this manner, the offset component of the AD converter 4 is canceled out immediately before the AD converter 4. Therefore, the black level can be measured without being affected by the offset component. The thus measured value of the black level is fed back by using the DA converter 12 and the subtractor 13.

As described above, according to the present embodiment, it is also possible to cancel the offset component of the AD converter so as to improve the precision of the adjustment.

(Embodiment 5)

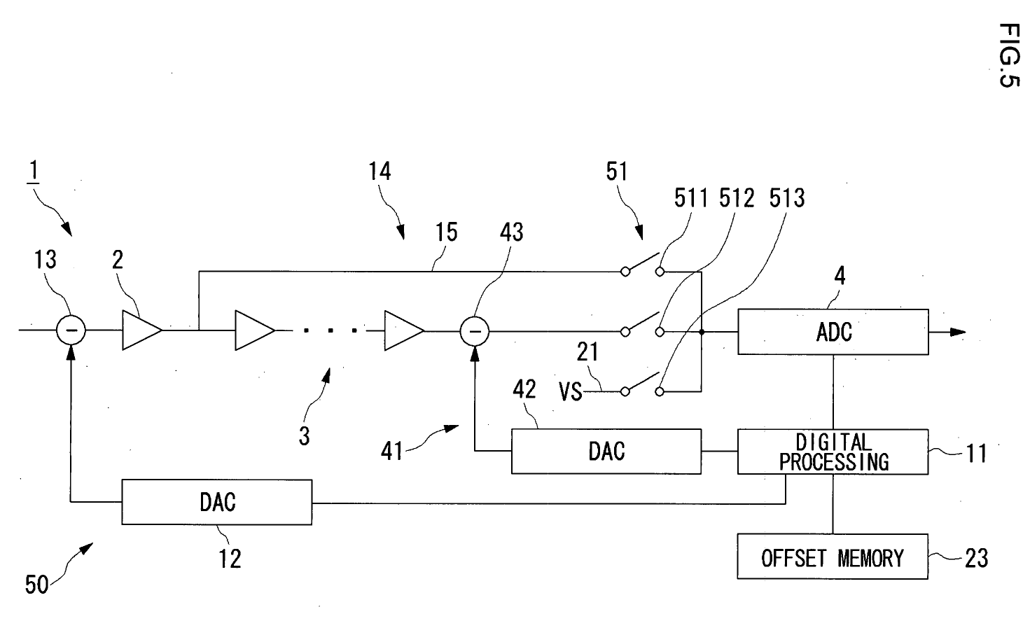

FIG. 5 illustrates a circuit structure according to a fifth embodiment of the present invention. In FIG. 5, the same parts as those in FIGS. 1 through 4 are labeled with the same reference numerals as those in FIGS. 1 through 4. In the following description, differences between the present embodiment and the aforementioned embodiments are mainly described.

The structure in the present embodiment corresponds to a combination of the structures of the fourth and first embodiments (FIGS. 4 and 1). A switching circuit 51 includes a switch 511 in the bypass circuit 14, a switch 512 in the main route, and a switch 513 in the reference voltage input line 21, and switches connection to the AD converter 4. The device shown in FIG. 5 operates in the following manner.

When the imaging signal is processed, the switch 511 is opened; the switch 512 is closed; and the switch 513 is opened. Thus, the PGA 3 is connected to the AD converter 4 and the imaging signal is processed.

When the offset component of the AD converter 4 is detected, the switches 511 and 512 are opened and the switch 513 is closed. Thus, the reference voltage input line 21 is connected to the AD converter 4, thereby the offset component of the AD converter 4 is detected.

The thus detected offset component is stored in the offset memory 23 via the digital processing circuit 11. This offset component is fed back through the feedback circuit 41. In other words, the offset component is supplied to the DA converter 42 so as to be converted into an analog signal. Then, the analog signal of the offset component is supplied to the subtractor 43. The subtractor 43 subtracts the offset component from the imaging signal, thereby canceling the offset component of the AD converter 4 that is mixed into the black level.

Measurement and adjustment of the black level are performed separately. In the measurement of the black level, the switch 511 is closed and the switches 512 and 513 are opened. Thus, the CDS 2 and the AD converter 4 are connected and therefore the black-level signal bypasses the PGA 3 so as to travel from the CDS 2 to the AD converter 4, so that the black-level signal is measured. The measured value of the black level is fed back by using the DA converter 12 and the subtractor 13, as described before.

As described above, according to the present embodiment, the advantageous effects obtained by allowing the signal to bypass the variable gain amplifier and canceling the offset component of the AD converter can be also achieved.

(Embodiment 6)

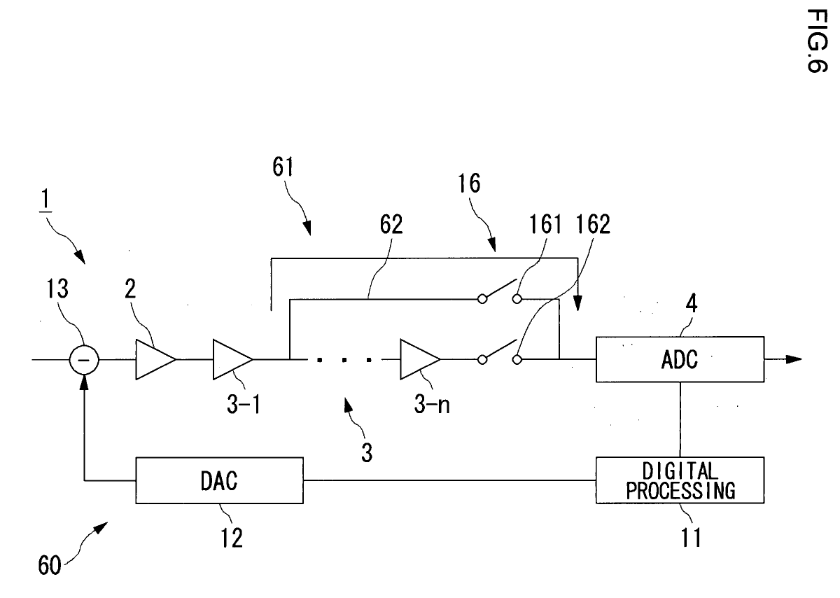

FIG. 6 illustrates a circuit structure according to a sixth embodiment of the present invention. In FIG. 6, the same parts as those in FIGS. 1 through 5 are labeled with the same reference numerals as those in FIGS. 1 through 5. In the following description, differences between the present embodiment and the aforementioned embodiments are mainly described.

The present embodiment corresponds to a modification of the first embodiment. In the present embodiment, a black-level adjustment circuit 60 also includes a bypass circuit 61 for allowing a signal to bypass the PGA 3 that is a variable gain amplifier. However, the bypass circuit 61 is different from the bypass circuit in the first embodiment in that the bypass circuit 61 allows the signal to bypass only a part of the PGA 3, instead of the entire PGA 3.

More specifically, the PGA 3 is formed by amplifiers 3-1, . . . , 3-n arranged in a plurality of stages. A bypass line 62 branches from the main route at a point immediately after the amplifier 3-1 and then merges into the main route at a point immediately before the AD converter 4. Thus, the bypass circuit 61 serves as a detour with respect to the amplifiers 3-2 (not shown), . . . , 3-n.

The device shown in FIG. 6 basically operates in a similar manner to that of the device shown in FIG. 1. When the imaging signal is processed, the switch 161 is opened and the switch 162 is closed. When the black level is measured, the switch 161 is closed and the switch 162 is opened.

As described above, within the scope of the present invention, it is not necessary for the bypass circuit to allow a signal to bypass the entire variable gain amplifier. In other words, the bypass circuit may provide a bypass with respect to a part of the variable gain amplifier, in accordance with circumstances such as demands from other parts of the device. Also in this case, the effect of the offset component of the bypassed amplifier can be removed. Therefore, it is not necessary to consider the offset of the bypassed amplifier, and the advantageous effect of the present invention can be achieved.

Moreover, the bypass circuit provides another advantageous effect that a time required for measurement of the black level can be reduced. A time (the number of clocks) required for signal processing in the analog front-end circuit 1 is in proportion to the number of the amplifiers in the PGA 3. The time required for measurement of the black level is also in proportion to the number of amplifiers through which the black-level signal passes. In the present embodiment, since the black-level signal bypasses at least a part of the amplifiers, the time for the measurement of the black level is reduced. The amount of this reduction is determined in accordance with the number of the bypassed amplifiers.

As described above, the present invention has an advantageous effect that a time required for measurement of the component to be adjusted can be reduced.

(Embodiment 7)

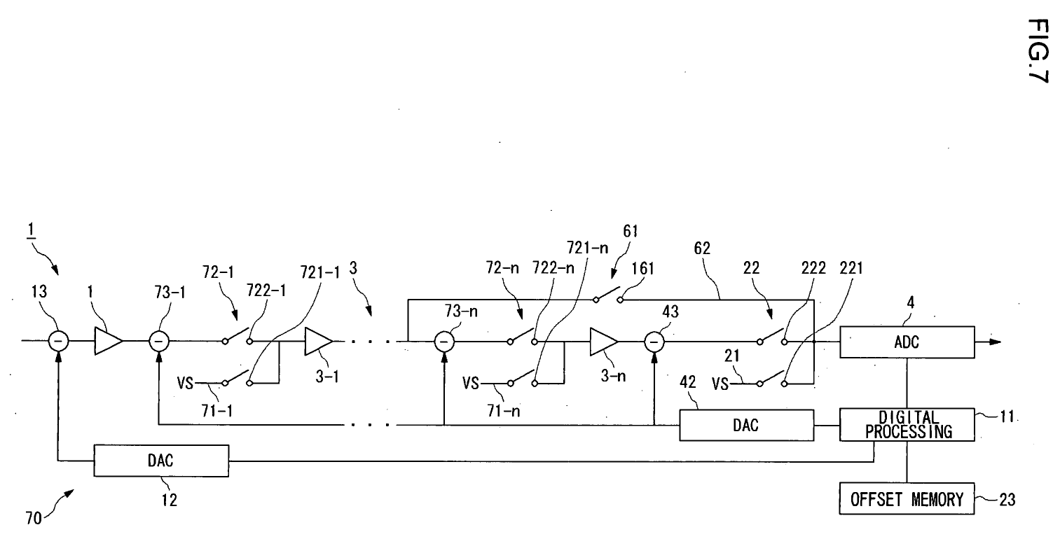

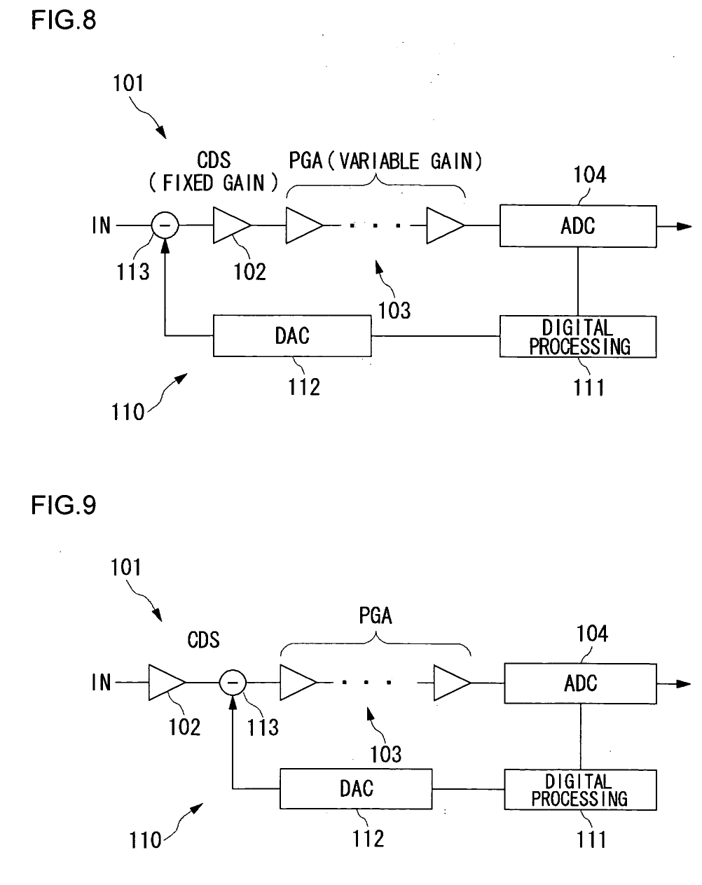

FIG. 7 illustrates a circuit structure according to a seventh embodiment of the present invention. In FIG. 7, the same parts as those in FIGS. 1 through 6 are labeled with the same reference numerals as those in FIGS. 1 through 6. In the following description, differences between the present embodiment and the aforementioned embodiments are mainly described.

The present embodiment corresponds to an application of the fourth embodiment. In the fourth embodiment, the structure for detecting and canceling the offset component of the AD converter 4 is provided. In the present embodiment, a similar structure is also provided for an amplifier in each stage in the PGA 3.

More specifically, in the present embodiment, the PGA 3 is formed by amplifiers 3-1, . . . , 3-n provided in a plurality of stages and reference voltage input lines 71-1, . . . , 71-n are connected to the corresponding amplifiers 3-1, . . . , 3-n, respectively, as shown in FIG. 7. Moreover, switching circuits 72-1, . . . , 72-n are provided for switching the main route and the reference voltage input lines 71-1, . . . , 71-n, respectively.

In addition, in order to cancel an offset component of each of the amplifiers 3-1, . . . , 3-n by feeding back that offset component, the DA converter 42 is connected to respective subtractors 73-1, . . . , 73-n provided immediately before the corresponding amplifiers 3-1, . . . , 3-n.

Furthermore, the bypass circuit 61 is provided as a bypass of the amplifier 3-n of the PGA 3 and is used in the measurement of the black level.

An operation of the device of the present embodiment is described. When the imaging signal is processed, the switches 722-1, . . . , 722-n and 222 in the main route are closed and other switches in FIG. 7 are opened. Thus, the imaging signal is processed by the CDS 2, the PGA 3, and the AD converter 4 in that order.

Next, detection of offset components is described. In the present embodiment, the offset component of the AD converter 4 and the offset components of the respective amplifiers 3-1, . . . , 3-n are detected individually.

When the offset component of-the AD converter 4 is detected, the switch 222 is opened and the switch 221 is closed. Thus, the reference voltage VS is input to the AD converter 4, so that the offset component of the AD converter 4 is detected in the above-described manner. The offset components of the amplifiers 3-1, . . . , 3-n are also detected similarly in principle.

More specifically, when the offset component of the amplifier 3-n is detected, the switch 722-n in the corresponding switching circuit 72-n provided before the amplifier 3-n is opened while the switch 721-n is closed, thereby the reference voltage VS is supplied to the amplifier 3-n. Thus, based on the similar principle to that of the detection of the offset component of the AD converter 4, the offset component of the amplifier 3-n is obtained from the AD converter 4.

The offset components of the other amplifiers can be measured similarly. In other words, by switching the switching circuits 72-1, 72-2, . . . , the reference voltage VS is input to the respective amplifiers 3-1, 3-2, . . . , so that the offset components are obtained.

When the offset component. of the amplifier is measured, in a part after the amplifier for which the measurement is performed, the switches in the main route are closed while the switches in the reference voltage input lines are opened. For example, in the measurement for the amplifier 3-n, the switch 222 that is arranged after the amplifier 3-n (before the AD converter 4) is closed, while the switch 221 is opened. In the measurement for the amplifier 3-1, the switching circuits provided immediately before all the amplifiers in the latter part operate similarly. The switch 161 in the bypass circuit 61 is opened in the measurement of the offset components.

After the offset components of the respective amplifiers 3-1, . . . , 3-n and the offset component of the AD converter 4 were obtained in the above-described manner, those offset components are stored in the offset memory 23. Those offset components are fed back via the DA converter 42 to the corresponding structures. For example, the offset component of the AD converter 4 is fed back to the subtractor 43 as described above, the offset component of the amplifier 3-n is fed back to the subtractor 73-n immediately before the amplifier 3-n, and the offset component of the amplifier 3-1 is fed back to the subtractor 73-1 immediately before the amplifier 3-1.

The bypass circuit 61 is also provided in the present embodiment and is used in the measurement of the black level. In the structure of FIG. 7, the bypass circuit 61 serves as a bypass of at least a part of the PGA 3 (amplifier 3-n). However, the bypass circuit 61 may serve as a bypass of the entire PGA 3.

As described above, in the present embodiment, both the advantageous effects provided by the bypass circuit and the advantageous effects provided by canceling the offset component of the AD converter can be achieved as in the aforementioned embodiments.

In the present embodiment, the offset component of the PGA 3 is further detected and canceled. In this manner, according to the present invention, the detection configuration for detecting the offset component may be also provided for the variable gain amplifier. In this case, by canceling the offset component of the variable gain amplifier, the adjustment precision can be improved.

Moreover, according to the present invention, the offset components of the respective amplifiers in the variable gain amplifier and the offset component of the AD converter are detected and canceled individually. Thus, the offset components can be removed more finely.

In the present embodiment, the offset components of all the amplifiers forming the variable gain amplifier are detected. However, within the scope of the present invention, the offset component of a part of the amplifiers may be detected and canceled.

In the above description, the preferred embodiments of the present invention have been described. However, it should be noted that the present invention is not limited to the above and those skilled in the art might make many changes to the above embodiments within the. scope of the present invention. For example, the present invention may not be limited to a circuit for adjusting a black level. The present invention may be applied to a signal adjustment circuit that removes another component to be adjusted by feeding back that component.

1. A signal adjustment circuit, provided in a signal processing circuit which processes a signal containing a component to be adjusted, the signal adjustment circuit removing the component to be adjusted from the signal passing through the signal processing circuit by feeding back the component to be adjusted, comprising:
a bypass circuit which allows a signal of the component to be adjusted that is to be fed back to bypass a gain amplifier forming the signal processing circuit when the signal of the component to be adjusted is measured.

2. The signal adjustment circuit according to claim 1, wherein the signal processing circuit comprises a correlated double sampling circuit, a programmable variable gain amplifier, and an AD converter, and
the bypass circuit allows the signal of the component to be adjusted to bypass the programmable variable gain amplifier.

3. The signal adjustment circuit according to claim 2, wherein the bypass circuit comprises a bypass line which connects the correlated double sampling circuit and the AD converter to each other, and a switching circuit which switches a route passing through the programmable variable gain amplifier and the bypass line.

4. The signal adjustment circuit according to claim 3, wherein the switching circuit comprises a first switch provided in the bypass line and a second switch provided between the programmable variable gain amplifier and the AD converter.

5. A black-level adjustment circuit of an imaging device, comprising the signal adjustment circuit according to claim 1, wherein
the signal processing circuit is an analog front-end circuit of the imaging device.

6. The black-level adjustment circuit according to claim 5, further comprising: a digital processing circuit; a DA converter; and a subtractor, wherein a measured value of a black level is fed back by the digital processing circuit, the DA converter, and the subtractor, and the bypass circuit allows a signal of the black level which is the signal of the component to be adjusted that is to be fed back, to bypass the gain amplifier.

7. An imaging device comprising the analog front-end circuit and the black-level adjustment circuit according to claim 5.

8. A signal adjustment circuit, provided in a signal processing circuit which processes a signal containing a component to be adjusted, the signal adjustment circuit removing the component to be adjusted from the signal passing through the signal processing circuit by feeding back the component to be adjusted, comprising:
a circuit which is operable to input a reference voltage to an AD converter forming the signal processing circuit; and
a circuit which cancels an offset component of the AD converter measured by using the reference voltage.

9. The signal adjustment circuit according to claim 8, wherein the input circuit comprises a reference voltage input line that is connected to the AD converter and inputs the reference voltage to the AD converter, and a switching circuit which switches a main route of a signal to be processed and the reference voltage input line, and
the cancel circuit comprises an offset memory which stores a detected value of the offset component of the AD converter and a digital processing circuit which reads the offset component from the offset memory and subtracts the offset component from the signal to be processed.

10. The signal adjustment circuit according to claim 9, wherein the signal processing circuit further comprises a correlated double sampling circuit and a programmable variable gain amplifier, and
the switching circuit comprises a first switch provided in the reference voltage input line and a second switch provided in the main route from the programmable variable gain amplifier.

11. A black-level adjustment circuit of an imaging device, comprising the signal adjustment circuit according to claim 8, wherein
the signal processing circuit is an analog front-end circuit of the imaging device.

12. The black-level adjustment circuit according to claim 11, wherein the input circuit comprises a reference voltage input line that is connected to the AD converter and inputs a reference voltage to the AD converter, and a switching circuit which switches a main route of a signal to be processed and the reference voltage input line, and
the cancel circuit comprises an offset memory which stores a detected value of the offset component of the AD converter that is detected before measurement of a black level, and a digital processing circuit which reads the offset component from the offset memory and subtracts the offset component from a measured value of the black level.

13. An imaging device comprising the analog front-end circuit and the black-level adjustment circuit according to claim 11.

14. A signal adjustment circuit, provided in a signal processing circuit which processes a signal containing a component to be adjusted, the signal adjustment circuit removing the component to be adjusted from the signal passing through the signal processing circuit by feeding back the component to be adjusted, comprising:
a bypass circuit which allows a signal of the component to be adjusted that is to be fed back to bypass a gain amplifier forming the signal processing circuit when the signal of the component to be adjusted is measured, wherein
the bypass circuit allows the signal of the component to be adjusted to bypass at least a part of amplifiers provided in a plurality of stages in the gain amplifier.

15. The signal adjustment circuit according to claim 14, wherein the gain amplifier is a programmable variable gain amplifier including the amplifiers provided in the plurality of stages.

16. A black-level adjustment circuit of an imaging device, comprising the signal adjustment circuit according to claim 14, wherein
the signal processing circuit is an analog front-end circuit of the imaging device.

17. An imaging device comprising the analog front-end circuit and the black-level adjustment circuit according to claim 16.

18. A signal adjustment circuit, provided in a signal processing circuit which processes a signal containing a component to be adjusted, the signal adjustment circuit removing the component to be adjusted from the signal passing through the signal processing circuit by feeding back the component to be adjusted, comprising:
a circuit which is operable to input a reference voltage to at least one of amplifiers provided in a plurality of stages in a gain amplifier forming the signal processing circuit; and
a circuit which cancels an offset component of the amplifier measured by using the reference voltage.

19. A black-level adjustment circuit of an imaging device, comprising the signal adjustment circuit according to claim 18, wherein
the signal processing circuit is an analog front-end circuit of the imaging device.

20. An imaging device comprising the analog front-end circuit and the black-level adjustment circuit according to claim 19.
